(19) United States
(12) Patent Application Publication
(10) Pub. No.: US 2024/0097161 A1
(43) Pub. Date: Mar. 21, 2024

(54) FUEL CELL MEMBRANE HUMIDIFIER AND FUEL CELL SYSTEM COMPRISING SAME

(71) Applicant: KOLON INDUSTRIES, INC., Seoul (KR)

(72) Inventors: Jung Kun HER, Seoul (KR); Do Woo KIM, Seoul (KR); Woong Jeon AN, Seoul (KR); Kyoung Ju KIM, Seoul (KR)

(21) Appl. No.: 18/253,944

(22) PCT Filed: Dec. 30, 2021
(86) PCT No.: PCT/KR2021/020252

§ 371 Date: May 23, 2023

(30) Foreign Application Priority Data
Dec. 31, 2020 (KR) 10-2020-0189268
Dec. 29, 2021 (KR) 10-2021-0191774

(51) Int. Cl. H01M 8/04119

(52) U.S. Cl. CPC H01M 8/04149

(57) ABSTRACT

The present disclosure provides a fuel cell membrane humidifier capable of regulating dry gas pressure in the fuel cell membrane humidifier by discharging dry gas to an outside according to the dry gas pressure in the membrane humidifier and a fuel cell system including the same, and
the fuel cell membrane humidifier according to an embodiment of the present disclosure
includes: a mid-case; a cap fastened to the mid-case and having a dry gas discharge hole through which dry gas is discharged; and a pressure regulator formed in the cap and partially opening the dry gas discharge hole according to pressure of dry gas in the cap to regulate the pressure of the dry gas in the cap.

### TECHNICAL FIELD

The present disclosure relates to a fuel cell membrane humidifier capable of regulating dry gas pressure in a fuel cell membrane humidifier by discharging dry gas to an outside according to the dry gas pressure in the membrane humidifier, and a fuel cell system including the same.

### BACKGROUND ART

A fuel cell is a power-generating cell that produces electricity by combining hydrogen and oxygen. A fuel cell can continuously produce electricity as long as hydrogen and oxygen are supplied, unlike conventional chemical batteries such as dry cells and storage batteries, and has the advantage of being about twice as efficient as internal combustion engines because there is no heat loss.

In addition, because chemical energy generated by a combination of hydrogen and oxygen is directly converted into electrical energy, fuel cells emit less pollutants. Therefore, fuel cells are not only environmentally friendly characteristics, but also reducing concerns about resource depletion due to increasing energy consumption.”

Depending on the type of electrolyte used, these fuel cells may be classified largely into Polymer Electrolyte Membrane Fuel Cell (PEMFC), Phosphoric Acid Fuel Cell (PAFC), and Molten Carbonate Fuel Cell (MCFC), solid oxide fuel cell (SOFC), and alkaline fuel cell (AFC).

Although each of these fuel cells operates on the same fundamental principle, they differ in the type of fuel used, operating temperature, catalyst, electrolyte, and other factors. Among them, Polymer Electrolyte Membrane Fuel Cell (PEMFC) is known to be the most promising fuel cell not only in small-scale stationary power generation equipment, but also in transportation systems, due to its operation at low temperatures compared to other fuel cells and high power density, which allows for miniaturization.

One of the most important factors in improving the performance of Polymer Electrolyte Membrane Fuel Cells (PEMFC) is to maintain function efficiency by supplying a certain amount of moisture to the Polymer Electrolyte Membrane (PEM) or Proton Exchange Membrane in the Membrane Electrode Assembly (MEA).” This is because when the polymer electrolyte membrane is dried, power generation efficiency is rapidly reduced.

There are several methods to humidify a Polymer Electrolyte Membrane, including 1) a bubbler humidification method for supplying moisture by passing a target gas through a diffuser after filling a pressure vessel with water, 2) a direct injection method for supplying moisture directly to a gas passage through a solenoid valve by calculating a required moisture supply for fuel cell reaction, and 3) a membrane humidifying method for supplying moisture to a gas fluid layer using a polymer separation membrane.

Among these methods, a membrane humidifying method for humidifying a polymer electrolyte membrane by supplying water vapor to gas to be supplied to the polymer electrolyte membrane, by use of a membrane which selectively allows only water vapor included in off-gas to pass therethrough is advantageous in that the humidifier can be lightweight and miniaturized.

The selective permeable membrane used in the membrane humidifying method is preferably a hollow fiber membrane having a large permeable area per unit volume when a module is formed. In other words, when a humidifier is manufactured using a hollow fiber membrane, high integration of hollow fiber membrane with large contact surface area is possible, so it is possible to sufficiently humidify a fuel cell even with a small capacity, to use low-cost materials, and to recover moisture and heat contained in off-gas discharged at a high temperature from the fuel cell and thus reuse the recovered moisture and heat through the humidifier.

FIG. 1 is a view showing a fuel cell membrane humidifier and a fuel cell system including the same according to a related art.

As shown in FIG. 1, the fuel cell system of the related art includes a blower B, a fuel cell membrane humidifier 10 (hereinafter referred to as “membrane humidifier”), a fuel cell stack S, and passages P1, P2, P3, and P4 connecting the aforementioned components. P1 is a dry gas supply passage for supplying dry gas collected in the blower B to the membrane humidifier 10, and P2 is a humidifying gas supply passage for supplying gas humidified in the membrane humidifier 10 to the fuel cell stack S. P3 is an off-gas supply passage for supplying off-gas discharged from the fuel cell stack S to the membrane humidifier 10, and P4 is an off-gas discharge passage for discharging off-gas with moisture exchanged to the outside.

The membrane humidifier 10 includes a humidifying module 11 in which moisture is exchanged between the dry gas supplied from the blower B and the off-gas (wet gas) discharged from the fuel cell stack S, and caps 12 and 13 coupled to both ends of the humidifying module 11.

A dry gas inlet 12a is formed in a cap 12 on the side of the blower B to supply the dry gas supplied from the blower B to the humidifying module 11, and a dry gas outlet 13a is formed in the cap 13 on the side of the stack S to supply the gas humidified by the humidifying module 11 to the fuel cell stack S.

The humidifying module 11 includes a mid-case 11a having an off-gas inlet 11aa and an off-gas outlet 11ab, and a plurality of hollow fiber membranes 11b within the mid-case 11a. Both ends of a bundle of hollow fiber membranes lib are fixed to a potting part 11c. The potting part 11c is generally formed by curing a liquid polymer such as liquid polyurethane resin through a casting method.

The dry gas supplied from the blower B flows along the hollow of the hollow fiber membranes lib. The off-gas introduced into the mid-case 11a through the off-gas inlet port 11aa contacts outer surfaces of the hollow fiber membranes 11b and is then discharged from the mid-case 11a through the off-gas outlet port 11ab. When the off-gas contacts the outer surfaces of the hollow fiber membranes 11b, moisture contained in the off-gas permeates the hollow fiber membranes 11b to humidify the dry gas flowing along the hollow of the hollow fiber membranes 11b.

Meanwhile, when the membrane humidifier 10 normally operates, the dry gas introduced into the dry gas inlet 12a is humidified while flowing along the hollow of the hollow fiber membranes 11b, and discharged to the fuel cell stack S through the dry gas outlet 13a.

However, when the membrane humidifier 10 does not operate normally due to various reasons such as abnormal operation of the fuel cell stack S, breakage of the hollow fiber membranes 11b, clogging of the passages of the hollow fiber membranes 11b, etc., the dry gas introduced through the dry gas inlet 12a may not be discharged through the dry gas outlet 13a. As a result, the pressure of the drying gas may increase in the membrane humidifier 10 and the membrane humidifier 10 may be damaged accordingly.

### DISCLOSURE

### Technical Problem

An object of the present disclosure is to provide a fuel cell membrane humidifier capable of regulating dry gas pressure in the fuel cell membrane humidifier by discharging dry gas to an outside according to dry gas pressure in a membrane humidifier, and a fuel cell system including the same.

### Technical Solution

### Technical Solution

A fuel cell membrane humidifier according to an embodiment of the present disclosure
includes: a mid-case; a cap fastened to the mid-case and having a dry gas discharge hole through which dry gas is discharged; and a pressure regulator formed in the cap and partially opening the dry gas discharge hole according to pressure of dry gas in the cap to regulate the pressure of the dry gas in the cap.

In the fuel cell membrane humidifier according to an embodiment of the present disclosure, the pressure regulator may include: a buffer housing communicating with the dry gas discharge hole; an opening and closing member moving forward and backward within the buffer housing; an elastic member formed in the opening and closing member and an inner wall of the buffer housing and compressing or expanding according to the pressure of the dry gas in the cap; and a gas outlet for discharging the dry gas introduced into the buffer housing to the outside.

In the fuel cell membrane humidifier according to an embodiment of the present disclosure, a protrusion may be formed in an opening on a side of the dry gas discharge hole of the buffer housing to extend from the cap and allowing the opening and closing member to be caught thereby.

In the fuel cell membrane humidifier according to an embodiment of the present disclosure, a protrusion protruding from the buffer housing and allowing the opening and closing member to be caught thereon may be formed.

In the fuel cell membrane humidifier according to an embodiment of the present disclosure, the pressure regulator may include: a buffer housing communicating with the dry gas discharge hole; an opening and closing member hinged to an upper end of the dry gas discharge hole and capable of pivoting; an elastic member formed behind the opening and closing member; and a gas outlet for discharging the dry gas introduced into the buffer housing to the outside.

In the fuel cell membrane humidifier according to an embodiment of the present disclosure, the pressure regulator may include: a buffer housing communicating with the dry gas discharge hole; an opening and closing member hinged to a lower end of the dry gas discharge hole and capable of pivoting; an elastic member formed in front of the opening and closing member; and a gas outlet for discharging the dry gas introduced into the buffer housing to the outside.

In the fuel cell membrane humidifier according to an embodiment of the present disclosure, the pressure regulator may include a thermally expandable metal formed in an inner wall of the cap and expanding according to a change in temperature of the dry gas in the cap; and a through-hole formed in the thermally expandable metal and partially opening the dry gas discharge hole according to expansion of the thermally expandable metal.

In the fuel cell membrane humidifier according to an embodiment of the present disclosure, the pressure regulator may further include a stopper formed at an end of the thermally expandable metal and formed of a heat-resistant material.

A fuel cell system according to an embodiment of the present disclosure
includes: a blower for supplying dry gas; a fuel cell stack; and a fuel cell membrane humidifier comprising a mid-case, a cap fastened to the mid-case and having a dry gas discharge hole through which dry gas is discharged, and a pressure regulator for regulating pressure of dry gas in the cap.

In the fuel cell system according to an embodiment of the present disclosure, the pressure regulator may include: a buffer housing communicating with the dry gas discharge hole; an opening and closing member moving forward and backward within the buffer housing; an elastic member formed in the opening and closing member and an inner wall of the buffer housing and compressing or expanding according to the pressure of the dry gas in the cap; and a gas outlet for discharging the dry gas introduced into the buffer housing to the outside.

In the fuel cell system according to the embodiment of the present disclosure, a protrusion formed extending from the cap and allowing the opening and closing member to be caught thereon may be formed on a side of the dry gas discharge hole of the buffer housing.

In the fuel cell system according to an embodiment of the present disclosure, a protrusion may be formed protruding from the buffer housing and allowing the opening and closing member to be caught thereon.

In the fuel cell system according to an embodiment of the present disclosure, the pressure regulator may include: a buffer housing communicating with the dry gas discharge hole; an opening and closing member hinged to an upper end of the dry gas discharge hole and capable of pivoting; an elastic member formed behind the opening and closing member; and a gas outlet for discharging the dry gas introduced into the buffer housing to the outside.

In the fuel cell system according to an embodiment of the present disclosure, the pressure regulator may include: a buffer housing communicating with the dry gas discharge hole; an opening and closing member hinged to a lower end of the dry gas discharge hole and capable of pivoting; an elastic member formed in front of the opening and closing member; and a gas outlet for discharging the dry gas introduced into the buffer housing to the outside.

In the fuel cell system according to an embodiment of the present disclosure, the pressure regulator may include: a thermally expandable metal formed in an inner wall of the cap and expanding according to a change in temperature of the dry gas in the cap; and a through-hole formed in the thermally expandable metal and partially opening the dry gas discharge hole according to expansion of the thermally expandable metal.

In the fuel cell system according to an embodiment of the present disclosure, the pressure regulator may further include a stopper formed at an end of the thermally expandable metal and formed of a heat-resistant material.

Other specific details of implementations according to various aspects of the present disclosure are included in the detailed description below.

### Advantageous Effects

In a fuel cell membrane humidifier and a fuel cell system including the same according to embodiments of the present disclosure, it is possible to adjust pressure of dry gas in the membrane humidifier by discharging the dry gas to an outside according to pressure of dry gas introduced into the membrane humidifier. Therefore, when the membrane humidifier does no operate normally for various reasons, it is possible to prevent damage to the membrane humidifier by regulating the pressure in the membrane humidifier.

### DESCRIPTION OF DRAWINGS

FIG. 1 is a diagram illustrating a fuel cell system according to a related art.

FIGS. 2 to 5 are diagrams illustrating a fuel cell membrane humidifier and a fuel cell system including the same according to embodiments of the present disclosure.

FIGS. 6, 8, 10 and 12 are diagrams illustrating a pressure regulator of a fuel cell membrane humidifier according to embodiments of the present disclosure.

FIGS. 7, 9, 11, and 13 are diagrams illustrating an operation process of a pressure regulator of a fuel cell membrane humidifier according to embodiments of the present disclosure.

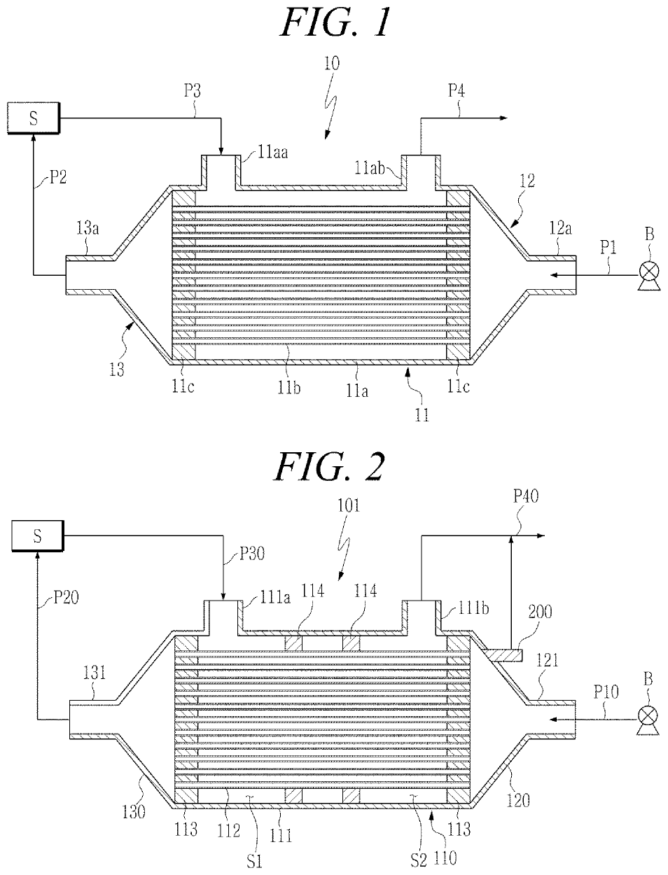

### MODE FOR DISCLOSURE

The present disclosure may include various modifications and embodiments, and therefore, the present disclosure will be explained in detail by taking exemplary embodiments. However, this is not intended to limit the present disclosure to the particular exemplary embodiments, and it should be noted that the present disclosure is intended to include all variations, equivalents, and substitutions that are included in the technical scope of the idea of the present disclosure.

The terms and expressions used in the present disclosure are used only for the purpose of illustrating particular embodiments, and are not intended to limit the present disclosure. Unless stated otherwise, an expression of singularity is intended to include expressions of plurality. It should be noted that the terms “include” or “have” as used in the present disclosure are intended to denote the existence of any features, numerical values, steps, operations, constituent elements, parts, and combinations thereof described in the specification, but are not intended to preliminarily exclude the possibility of existence or addition of any one or more other features, numerical values, steps, operations, constituent elements, parts, and combinations thereof. Hereinafter, a fuel cell membrane humidifier and a fuel cell system including the same according to an embodiment of the present disclosure will be described with reference to the drawings.

FIGS. 2 to 5 are diagrams illustrating a fuel cell membrane humidifier and a fuel cell system including the same according to embodiments of the present disclosure.

As shown in FIGS. 2 to 5, a fuel cell membrane humidifier and a fuel cell system including the same according to embodiments of the present disclosure include a blower B, a fuel cell membrane humidifier 100 (101 to 104) (hereinafter also referred to as a “membrane humidifier”), a fuel cell stack S, and flow passages P10, P20, P30, and P40 connecting the aforementioned components.

The blower B collects gas in the air and supplies the collected gas to the membrane humidifier 100 (101 to 104). An output size of the blower B may be determined according to an output size of the fuel cell stack S. Optionally, a filter (not shown) for removing fine dust may be installed at a front of the blower B, and a cooler (not shown) for cooling dry gas supplied into the membrane humidifier 100 may be installed between the blower B and the membrane humidifier 100.

The membrane humidifier 100 humidifies the dry gas and supplies the humidified gas to the fuel cell stack S. The membrane humidifier 100 includes a humidifying module 110 for humidifying the dry gas supplied from the blower B with moisture contained in off-gas discharged from the fuel cell stack S. Both ends of the humidifying module 110 are coupled to the caps 120 and 130, respectively. The humidifying module 110 and the caps 120 and 130 may be formed separately or integrally.

A dry gas inlet 121 may be formed in the cap 120 on the side of the blower B to supply the dry gas supplied from the blower B to the humidifying module 110, and a dry gas outlet 131 is formed in the cap 120 on the side of the stack S to supply the gas humidified by the humidifying module 110 to the fuel cell stack S.

In the cap 120 on the side of the blower B, a pressure regulator 200 (210 to 240) to be closed or open according to pressure of dry gas in the gap 120 to regulate dry gas pressure in the cap 120 may be formed. The pressure regulator 200 (210 to 240) will be described later with reference to FIGS. 6 to 13.

The dry gas inlet 121 is connected to a dry gas supply passage P10 connecting the blower B and the membrane humidifier 100, and the dry gas outlet 131 is connected to a humidified gas supply passage P20 connecting the cap 130 on the side of the fuel cell stack S and the fuel cell stack S. The off-gas discharged from the fuel cell stack S is supplied to the membrane humidifier 100 through an off-gas supply passage P30, and the off-gas with moisture exchanged in the membrane humidifier 100 is discharged to the outside through an off-gas discharge passage P40.

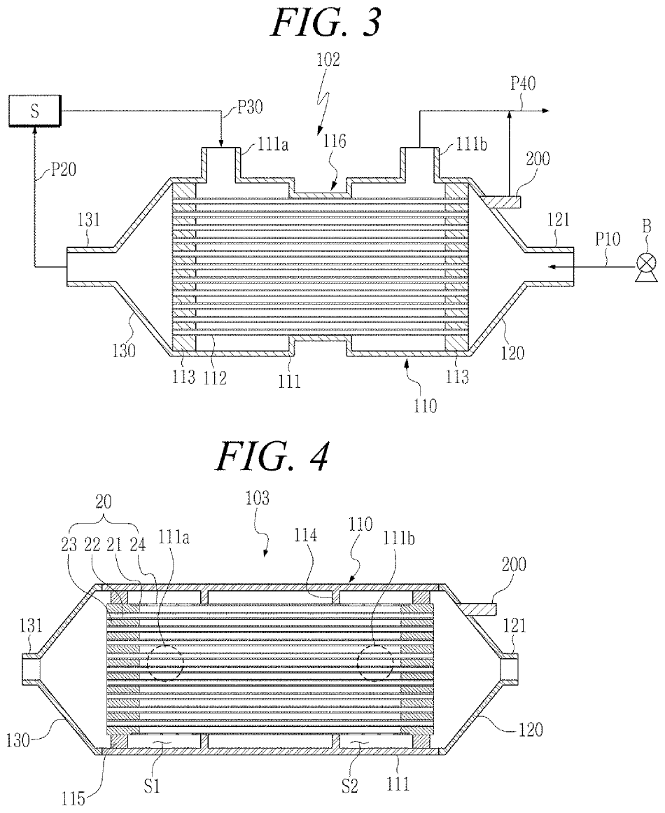

As shown in FIGS. 2 and 3, the humidifying module 110 is a device for exchanging moisture between the off-gas and the dry gas supplied from the blower B, and includes a mid-case 111 having an off-gas inlet 111a and an off-gas outlet 111b and a plurality of hollow fiber membranes 112 accommodated in the mid-case 111. Both ends of a bundle of hollow fiber membranes 112 are fixed to a potting part 113.

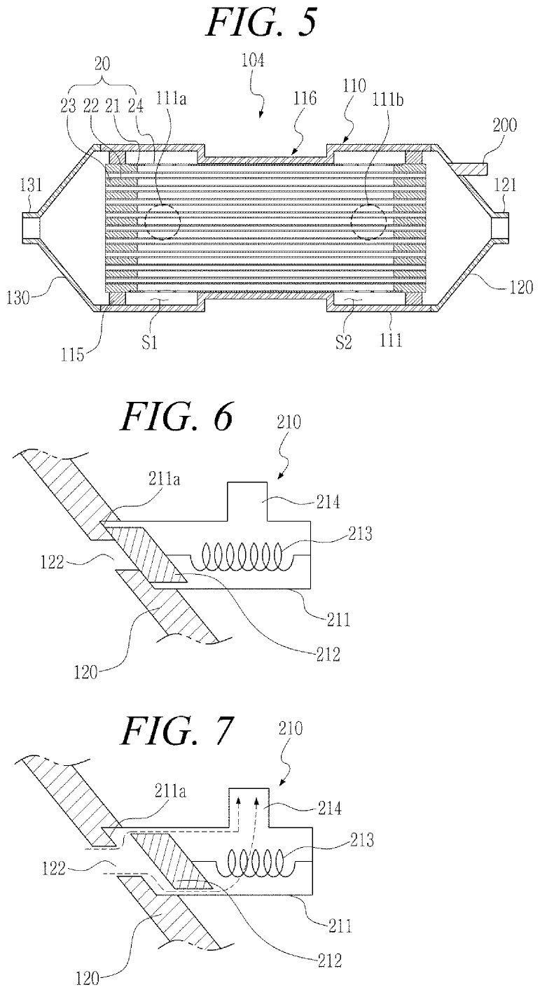

Alternatively, as shown in FIGS. 4 and 5, the humidifying module 110 includes at least one cartridge 20 including a plurality of hollow fiber membranes 22 and a potting part 23 for fixing the same to each other, and in this case, the hollow fiber membranes 22 and the potting part 23 may be formed in an inner case 21, which is a separate cartridge case. In this case, the hollow fiber membranes 22 may be accommodated in the inner case 21, and the potting part 23 may be formed at an end of the inner case 21. When the humidifying module 110 includes a cartridge 20, a fixing layer 115 for fixing the cartridge may be formed between both ends of the cartridge and the mid-case 111. The fixing layer 115 may be a resin layer formed of resin or a gasket assembly that is air-tightly coupled through mechanical assembling. The inner case 21 includes mesh holes 24 arranged in a mesh shape for fluid communication with a first space S1 and a second space S2.

As shown in FIGS. 2 and 4, the internal space of the mid-case 111 may be divided into a first space S1 and a second space S2 by the partition wall 114. Partitions 114 may prevent the off-gas flowing into the off-gas inlet 111a from directly flowing into the off-gas outlet 111b by bypassing the hollow fiber membranes 112 and 22 without moisture exchange.

Alternatively, as shown in FIGS. 3 and 5, an internal space of the mid-case 111 may be divided into the first space S1 and the second space by a central recessed portion 116 recessed at the center of the mid-case 111. The central recessed portion 116 may prevent the off-gas introduced into the off-gas inlet 111a from directly flowing into the off-gas outlet 111b by bypassing without exchanging moisture with the hollow fiber membranes 112 and 22.

The mid-case 111 and the caps 120 and 130 may be independently formed of hard plastic or metal, and may have circular or polygonal cross sections in a width direction. “Circular” includes ovals, and “polygonal” includes polygons with rounded corners. For example, the hard plastic may be polycarbonate, polyamide (PA), polyphthalamide (PPA), polypropylene (PP), or the like.

The hollow fiber membranes 112 and 22 may include a polymer film that is formed of polysulfone resin, polyethersulfone resin, sulfonated polysulfone resin, polyvinylidene fluoride (PVDF) resin, polyacrylonitrile (PAN) resin, polyimide resin, and polyamideimide resin, a polyesterimide resin, or a mixture of at least two thereof, and the potting part 113 may be formed by curing a liquid resin such as a liquid polyurethane resin through a casting method such as deep potting or centrifugal potting.

In the exemplary embodiments of the present disclosure shown in FIGS. 2 to 5, the pressure regulator 200 (210 to 240) to be closed or open by dry gas pressure in the cap 120 to thereby regulate dry gas pressure in the cap 120 is formed in the cap 120 on the side of the blower B. This will be described with reference to FIGS. 6 to 13.

FIG. 6 is a diagram illustrating a pressure regulator according to a first embodiment, and FIG. 7 is a diagram illustrating an operation process of the pressure regulator according to the first embodiment.

As shown in FIG. 6, a pressure regulator 210 of the first embodiment may include a buffer housing 211, an opening and closing member 212, an elastic member 213, and a gas outlet 214.

The buffer housing 211 has a predetermined shape and is formed to communicate with the dry gas discharge hole 122 formed in the cap 120. The buffer housing 211 provides a space for the opening and closing member 212 to move forward and backward, and provides a space where the dry gas in the cap 120 can move when the opening and closing member 212 moves backward to open the dry gas discharge hole 122.

In an opening on the side of the dry gas discharge hole 122 of the buffer housing 211, a protrusion 211a extending from the cap 120 and allowing the opening and closing member 212 to be caught thereby may be formed. Alternatively, the protrusion 211a may protrude from at least one of an upper surface and a lower surface of the buffer housing 211.

The opening and closing member 212 has an area larger than that of the dry gas discharge hole 122 so as to be caught by the protrusion 211a, and is formed in a shape for opening and closing the dry gas discharge hole 122.

A front surface of the opening and closing member 212 opens and closes the dry gas discharge hole 122, and in a rear surface of the opening and closing member 212, an elastic member 213 capable of compressing or expanding according to pressure of the dry gas in the cap 120 is formed. The elastic member 213 may be fixed and formed in the rear surface of the opening and closing member 212 and an inner wall of one side of the buffer housing 211. The elastic member 213 may be, for example, a spring. Of course, it is not limited thereto, and heat-resistant rubber, synthetic resin, etc. may be used as a material for the elastic member 213.

A gas outlet 214 is formed in at least one surface of the buffer housing 211. As shown in FIG. 7, when the opening and closing member 212 moves backward to open the dry gas discharge hole 122, the dry gas in the cap 120 is introduced into the buffer housing 211 through the dry gas discharge hole 122 and discharged to the outside through the gas outlet 214 and the off-gas discharge passage P40 (see FIG. 2).

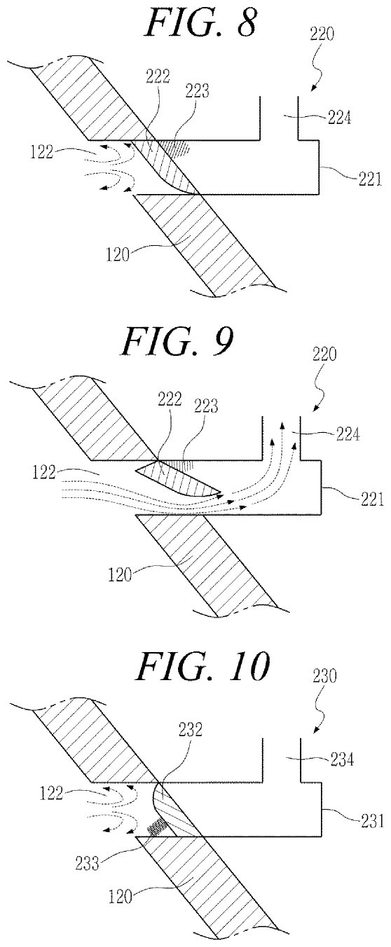

FIG. 8 is a diagram illustrating a pressure regulator according to a second embodiment, and FIG. 9 is a diagram illustrating an operation process of the pressure regulator according to the second embodiment.

As shown in FIG. 8, a pressure regulator 220 according to the second embodiment may include a buffer housing 221, an opening and closing member 222, an elastic member 223, and a gas outlet 224.

The buffer housing 221 has a predetermined shape and is formed to communicate with the dry gas discharge hole 122 formed in the cap 120. The buffer housing 221 provides a space in which the hinged opening and closing member 222 can pivot, and provides a space where the dry gas in the cap 120 can move when the opening and closing member 222 pivots backward to partially open the dry gas discharge hole 122. Here, the inner side of the cap is referred to as “front”, and the outer side of the cap is referred to as “rear”.

The opening and closing member 222 is hinge-connected to an upper end of the dry gas discharge hole 122, and an end thereof is formed in an arch shape so as to be pivotable without friction according to the pressure of the dry gas.

A front surface of the opening and closing member 222 opens and closes the dry gas discharge hole 122, and in a rear surface of the opening and closing member 222, an elastic member 223 capable of compressing or expanding according to the pressure of the dry gas in the cap 120 is formed. The elastic member 223 may be fixed and formed in the rear surface of the opening and closing member 222 and an upper inner wall of the buffer housing 221. The elastic member 223 may be, for example, a spring. Of course, it is not limited thereto, and heat-resistant rubber, synthetic resin, etc. may be used as a material for the elastic member 223.

A gas outlet 224 is formed on at least one surface of the buffer housing 221. As shown in FIG. 9, when the opening and closing member 222 pivots backward to open the dry gas discharge hole 122, the dry gas in the cap 120 is introduced into the buffer housing 221 through the dry gas discharge hole 122 and discharged to the outside through the gas outlet 224 and the off-gas discharge passage P40 (see FIG. 2).

FIG. 10 is a diagram illustrating a pressure regulator according to a third embodiment, and FIG. 11 is a diagram illustrating an operation process of the pressure regulator according to the third embodiment.

As shown in FIG. 10, a pressure regulator 230 according to the third embodiment may include a buffer housing 231, an opening and closing member 232, an elastic member 233, and a gas outlet 234. Compared to the pressure regulator 220 of the second embodiment, the installation positions of the opening and closing member 232 and the elastic member 233 are different, but other configuration of the pressure regulator 230 of the third embodiment are substantially the same, and thus, a repeated description thereof will be omitted.

In this embodiment, the opening and closing member 232 is hinged to a lower end of the dry gas discharge hole 122, and an end thereof is formed in an arch shape so as to be pivotable without friction according to the pressure of the dry gas.

A front surface of the opening and closing member 232 opens and closes the dry gas discharge hole 122, and in a rear surface of the opening and closing member 232, an elastic member 233 capable of compressing or extending according to the pressure of the dry gas in the cap 120 is formed. The elastic member 233 may be fixed and formed in the front surface of the opening and closing member 232 and an inner wall of the dry gas discharge hole 122.

As shown in FIG. 11, when the opening and closing member 232 pivots backward to open the dry gas discharge hole 122, the dry gas in the cap 120 is introduced into the buffer housing 231 through the dry gas discharge hole 122 and discharged to the outside through the gas outlet 234 and the off-gas discharge passage P40 (see FIG. 2).

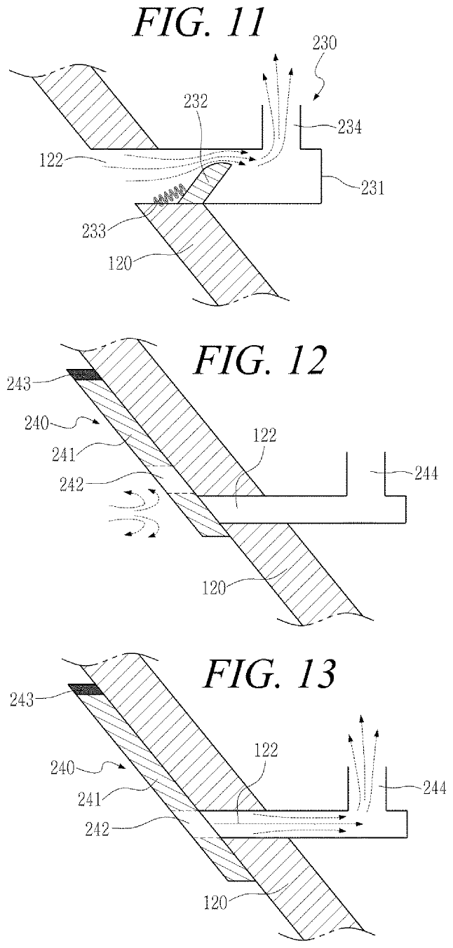

FIG. 12 is a diagram illustrating a pressure regulator according to a fourth embodiment, and FIG. 13 is a diagram illustrating an operation process of the pressure regulator according to the fourth embodiment.

As shown in FIG. 12, a pressure regulator 240 according to the fourth embodiment may include a thermally expandable metal 241, a through hole 242, a stopper 243, and a gas outlet 244.

The thermally expandable metal 241 is generally formed in a bar shape near the dry gas discharge hole 122 on the inner wall of the cap 120. The thermally expandable metal 241 is formed of a metal material capable of expanding or contracting according to a change in temperature of the drying gas.

The through-hole 242 penetrating the thermally expandable metal 241 is formed at a predetermined position of the thermally expandable metal 241. The through hole 242 is formed in a shape corresponding to the shape of the dry gas discharge hole 122, and may partially open the dry gas discharge hole 122 according to expansion of the thermally expandable metal 241 and close the dry gas discharge hole 122 according to contraction of the thermally expandable metal 241.

The stopper 243 may be formed at an end of the thermally expandable metal 241. The stopper 243 is formed of a heat-resistant material that expands/contracts less according to a change in temperature of the dry gas than the thermally expandable metal 241, and serves as a starting point of expansion or contraction of the thermally expandable metal 241.

The gas outlet 244 is formed to communicate with the dry gas outlet hole 122.

When the membrane humidifier operates normally, the dry gas in the cap 120 has a constant pressure and the temperature thereof may be maintained at a constant level. (Ideal Gas Equation) In this case, as shown in FIG. 12, the thermally expandable metal 241 remains in an unexpanded state, and the through hole 242 remains at a position to close the dry gas discharge hole 122.

When the membrane humidifier operates abnormally, the pressure of the dry gas in the cap 120 is increased and the temperature is also increased accordingly. In this case, as shown in FIG. 13, the thermally expandable metal 241 expands, and the through hole 242 moves according to the expansion of the thermally expandable metal 241 and is disposed at a position to open the dry gas discharge hole 122.

When the dry gas discharge hole 122 is opened, the dry gas in the cap 120 is discharged to the outside through the dry gas discharge hole 122, the gas outlet 244, and the off-gas discharge passage P40 (see FIG. 2).

After a certain period of time, when the dry gas is discharged and the pressure is lowered, the temperature is also lowered, and the thermally expandable metal 241 contracts the through-hole 242 returns to its original position, and, as shown in FIG. 12, the through-hole 242 closes the dry gas discharge hole 122.

According to a fuel cell membrane humidifier and a fuel cell system including the same according to embodiments of the present disclosure, it is possible to regulate pressure of dry gas in the membrane humidifier by discharging the dry gas to an outside according to pressure of the dry gas introduced into the membrane humidifier.

Therefore, when the membrane humidifier does no operate normally for various reasons, it is possible to prevent damage to the membrane humidifier by regulating the pressure in the membrane humidifier.

While the present disclosure has been particularly shown and described with reference to exemplary embodiments thereof, it will be understood by those of ordinary skill in the art that various modifications and changes may be made therein through inclusion, alteration, removal or addition of elements without departing from the spirit and scope of the present disclosure as defined by the following claims.

[Detailed Description of Main Elements]

| | |
|---|---|
| 100 (100 to 104): fuel cell | |
| membrane humidifier | |
| 110: humidifying module | 111: mid-case |
| 112: hollow fiber membrane | 113: potting part |
| 114: partitions | 116: central recessed portion |
| 111a: off-gas inlet | 111b: off-gas outlet |
| 20: cartridge | 21: inner case |
| 22: hollow fiber membrane | 23: potting part |
| 24: mesh holes | |
| 120, 130: cap | |
| 200 (210 to 240): pressure regulator | |
| B: blower | S: fuel cell stack |
| P10: dry gas supply passage | P20: dry gas supply passage |
| P30: off-gas supply passage | P40: off-gas discharge passage |

1. A fuel cell membrane humidifier comprising:
a mid-case;
a cap fastened to the mid-case and having a dry gas discharge hole through which dry gas is discharged; and
a pressure regulator formed in the cap and partially opening the dry gas discharge hole according to pressure of dry gas in the cap to regulate the pressure of the dry gas in the cap.

2. The fuel cell membrane humidifier of claim 1, wherein the pressure regulator comprises:
a buffer housing communicating with the dry gas discharge hole;
an opening and closing member moving forward and backward within the buffer housing;
an elastic member formed in the opening and closing member and an inner wall of the buffer housing and compressing or expanding according to the pressure of the dry gas in the cap; and
a gas outlet for discharging the dry gas introduced into the buffer housing to the outside.

3. The fuel cell membrane humidifier of claim 2, wherein a protrusion is formed in an opening on a side of the dry gas discharge hole of the buffer housing to extend from the cap and allowing the opening and closing member to be caught thereby.

4. The fuel cell membrane humidifier of claim 2, wherein a protrusion protruding from the buffer housing and allowing the opening and closing member to be caught thereon is formed.

5. The fuel cell membrane humidifier of claim 1, wherein the pressure regulator comprises:
a buffer housing communicating with the dry gas discharge hole;
an opening and closing member hinged to an upper end of the dry gas discharge hole and capable of pivoting;
an elastic member formed behind the opening and closing member; and
a gas outlet for discharging the dry gas introduced into the buffer housing to the outside.

6. The fuel cell membrane humidifier of claim 1, wherein the pressure regulator comprises:
a buffer housing communicating with the dry gas discharge hole;
an opening and closing member hinged to a lower end of the dry gas discharge hole and capable of pivoting;
an elastic member formed in front of the opening and closing member; and
a gas outlet for discharging the dry gas introduced into the buffer housing to the outside.

7. The fuel cell membrane humidifier of claim 1, wherein the pressure regulator comprises:
a thermally expandable metal formed in an inner wall of the cap and expanding according to a change in temperature of the dry gas in the cap; and
a through-hole formed in the thermally expandable metal and partially opening the dry gas discharge hole according to expansion of the thermally expandable metal.

8. The fuel cell membrane humidifier according to claim 7, wherein the pressure regulator further comprises a stopper formed at an end of the thermally expandable metal and formed of a heat-resistant material.

9. A fuel cell system comprising:
a blower for supplying dry gas;
a fuel cell stack; and
a fuel cell membrane humidifier comprising a mid-case, a cap fastened to the mid-case and having a dry gas discharge hole through which dry gas is discharged, and a pressure regulator for regulating pressure of dry gas in the cap.

10. The fuel cell system of claim 9, wherein the pressure regulator comprises:
a buffer housing communicating with the dry gas discharge hole;
an opening and closing member moving forward and backward within the buffer housing;
an elastic member formed in the opening and closing member and an inner wall of the buffer housing and compressing or expanding according to the pressure of the dry gas in the cap; and
a gas outlet for discharging the dry gas introduced into the buffer housing to the outside.

11. The fuel cell regulator of claim 10, wherein a protrusion formed extending from the cap and allowing the opening and closing member to be caught thereon is formed on a side of the dry gas discharge hole of the buffer housing.

12. The fuel cell regulator of claim 10, wherein a protrusion is formed protruding from the buffer housing and allowing the opening and closing member to be caught thereon.

13. The fuel cell system of claim 9, wherein the pressure regulator comprises:
a buffer housing communicating with the dry gas discharge hole;
an opening and closing member hinged to an upper end of the dry gas discharge hole and capable of pivoting;
an elastic member formed behind the opening and closing member; and
a gas outlet for discharging the dry gas introduced into the buffer housing to the outside.

14. The fuel cell system of claim 9, wherein the pressure regulator comprises:
a buffer housing communicating with the dry gas discharge hole;
an opening and closing member hinged to a lower end of the dry gas discharge hole and capable of pivoting;
an elastic member formed in front of the opening and closing member; and
a gas outlet for discharging the dry gas introduced into the buffer housing to the outside.

15. The fuel cell system of claim 9, wherein the pressure regulator comprises:
a thermally expandable metal formed in an inner wall of the cap and expanding according to a change in temperature of the dry gas in the cap; and
a through-hole formed in the thermally expandable metal and partially opening the dry gas discharge hole according to expansion of the thermally expandable metal.

16. The fuel cell system of claim 15, wherein the pressure regulator further comprises:
a stopper formed at an end of the thermally expandable metal and formed of a heat-resistant material.

17. The fuel cell system of claim 9, comprising:
a humidifying gas supply passage for supplying the gas humidified in the fuel cell membrane humidifier to the fuel cell stack;
an off-gas supply passage for supplying off-gas discharged from the fuel cell stack to the fuel cell membrane humidifier; and
an off-gas discharge passage for discharging the off-gas exchanged with water in the fuel cell membrane humidifier to the outside.
